(19) United States
(12) Patent Application Publication
(10) Pub. No.: US 2025/0008229 A1
(43) Pub. Date: Jan. 2, 2025

(54) Adaptive Depth of Field for a Noncircular Aperture

(71) Applicant: Motorola Mobility LLC, Chicago, IL (US)

(72) Inventors: James P Ashley, Naperville, IL (US); John Pincenti, Chicago, IL (US)

(73) Assignee: Motorola Mobility LLC, Chicago, IL (US)

(21) Appl. No.: 18/342,512

(22) Filed: Jun. 27, 2023

(51) Int. Cl. H04N 23/81; G03B 11/00; H04N 23/67

(52) U.S. Cl. CPC H04N 23/81; G03B 11/00; H04N 23/67

(57) ABSTRACT

In aspects of adaptive depth of field for noncircular aperture, a camera device includes a camera imager with a noncircular aperture. The camera imager captures image content at a depth of field, and the image content has an identifiable characteristic resulting from the noncircular aperture of the camera imager. The camera device implements a content manager that adaptively adjusts a perceived depth of field to sharpen a portion of the image content based on the identifiable characteristic resulting from the noncircular aperture of the camera imager.

### BACKGROUND

Many types of portable devices, such as mobile phones, camera devices, and other electronic devices, include one or more camera modules used to capture digital photos. However, these devices may have a shallow depth of field, which provides the capability to focus on an item in the foreground of a photo, but results in a blurry background of the photo. Typically, the depth of field can depend on several factors, such as lens focal length, lens aperture, lens focal position, and the distance from the camera lens to the subject. Given the compact form factor of portable, electronic devices, there is not space in a device to incorporate the type of hardware, camera lens, and camera imager that would provide a sufficient depth of field to produce some types of clearly focused digital photos.

### BRIEF DESCRIPTION OF THE DRAWINGS

Implementations of the techniques for adaptive depth of field for a noncircular aperture are described with reference to the following Figures. The same numbers may be used throughout to reference like features and components shown in the Figures:

FIG. 1 illustrates an example system for adaptive depth of field for a noncircular aperture in accordance with one or more implementations as described herein.

FIG. 2 illustrates an example of the machine learning model processing image content, as related to adaptive depth of field for a noncircular aperture in accordance with one or more implementations described herein.

FIG. 3 illustrates an example of a degradation model usable to generate a training image pair, as related to adaptive depth of field for a noncircular aperture in accordance with one or more implementations described herein.

FIG. 4 illustrates an example of training a machine learning model (e.g., an AI model) to learn the inverse of the degradation model, as related to adaptive depth of field for a noncircular aperture in accordance with one or more implementations described herein.

FIG. 5 illustrates an example of processing test images through the trained machine learning model, as related to adaptive depth of field for a noncircular aperture in accordance with one or more implementations described herein.

FIGS. 6-8 illustrate example methods for adaptive depth of field for a noncircular aperture in accordance with one or more implementations of the techniques described herein.

FIG. 9 illustrates various components of an example device that can be used to implement the techniques for adaptive depth of field for a noncircular aperture as described herein.

### DETAILED DESCRIPTION

Implementations of techniques for adaptive depth of field for a noncircular aperture are implemented as described herein. A mobile device (e.g., any type of mobile phone, wireless device, and/or electronic device) includes a camera device that has a camera lens, or camera module, which may be implemented with a noncircular aperture, such as a slit aperture, rectangular aperture, or any other type of asymmetrical aperture that is not a typical round camera aperture. Typical cameras in mobile devices, for example, are constrained by size and cost, and are therefore limited in performance. Further, the front surface of many mobile devices are almost entirely devoted to a full-surface touch screen display, and the front-facing camera of a device is either narrowed with a noncircular (e.g., asymmetrical) aperture in the narrow bezel around the touch screen display, or installed under the touch screen display. In implementations, the noncircular aperture is of a dimension that is smaller than that of the imager, and environment light that is directed through the noncircular aperture is reduced, has a corresponding noncircular shape, and does not fully cover the camera imager.

However, a camera device and imager with a noncircular aperture, such as in a mobile device, can lead to a shallow depth of field, which provides the overall capability to focus on an item in the foreground of a photo, but results in a blurry background of the photo. Notably, limitations in depth of field can cause unwanted or excessive blur in images, especially in fixed focal length cameras that are commonly used for the front-facing (selfie) cameras in mobile devices. Conventional sharpening and de-blurring techniques may produce inconsistent results, such has when certain regions of an image may be improved, while other regions can be made significantly worse.

In aspects of the described adaptive depth of field for a noncircular aperture, a camera device includes a camera imager with a noncircular aperture, such as a slit aperture or a rectangular aperture, or generally, any type of an asymmetrical aperture that is shaped as something other than a conventional circular aperture. Given the limited adjustment flexibility of a fixed focal length camera in the compact form factor of a mobile device (e.g., a wireless phone), the camera imager captures image content (e.g., a digital photo) at the particular depth of field of the camera. Notably, the image content that is captured by the camera imager has an identifiable characteristic resulting from the noncircular aperture of the camera imager, and this identifiable characteristic can be utilized as a basis to sharpen a distorted portion of the image content.

In aspects of the described techniques, the perception of depth of field can be adaptively adjusted, such as by synthetically increasing the perceived depth of field to compensate for the identifiable characteristic resulting from the noncircular aperture. The depth of field issues can also be addressed using the optical properties of the specific camera being used in the device, and inverting the effects that the camera optics have on the perceived depth of field. More specifically, a large set of optical point spread functions (PSFs) can be calculated for the camera module, and used to degrade a set of reference images. In one or more implementations, these reference and degraded images can then be used by a machine learning model or algorithm (e.g., an AI algorithm) to estimate the inverse of these PSF functions. The resulting model can then be used on-device to selectively (by virtue of the machine learning (ML) model) invert the perceived depth of field artifacts produced by the camera module. Accordingly, the machine learning model is implemented to correct a blur or reduce noise of the distorted portion of the image content.

In aspects of the described techniques, a mobile device, or a camera device that is implemented in a mobile device, includes a content manager that adaptively adjusts a perceived depth of field to sharpen a portion of the image content based on the identifiable characteristic resulting from the noncircular aperture of the camera imager. In one or more implementations, the content manager includes, or is implemented as, the machine learning model that corrects the blur or reduces the noise of the distorted portion of the image content. The content manager and/or the machine learning model may be implemented as artificial intelligence (AI), a machine learning (ML) model or algorithm, a convolutional neural network (CNN), and/or any other type of machine learning model to eliminate the blur and/or reduce the noise in captured image content. As used herein, the term “machine learning model” refers to a computer representation that is trainable based on inputs to approximate unknown functions. For example, a machine learning model can utilize algorithms to learn from, and make predictions on, inputs of known data (e.g., training and/or reference images) by analyzing the known data to learn to generate outputs, such as to correct distortions in image content, as described herein.

While features and concepts of the described techniques for adaptive depth of field for a noncircular aperture can be implemented in any number of different devices, systems, environments, and/or configurations, implementations of the techniques for adaptive depth of field for a noncircular aperture are described in the context of the following example devices, systems, and methods.

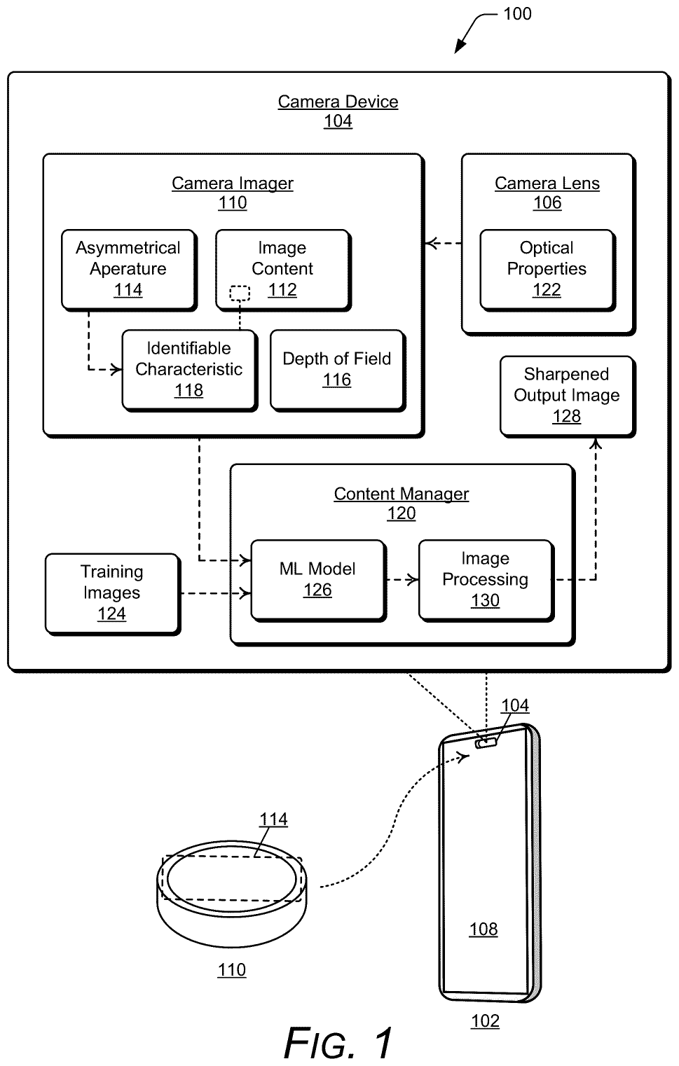

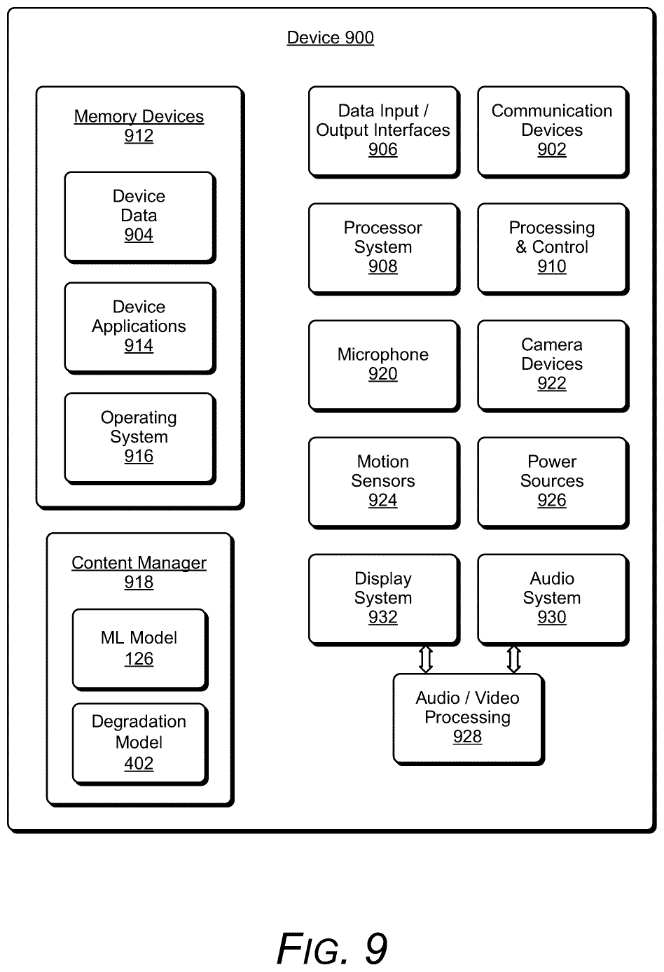

FIG. 1 illustrates an example system 100 for adaptive depth of field for a noncircular aperture, as described herein. The system 100 includes a mobile device 102, such as a smartphone, mobile phone, wireless device, tablet device, and/or any other type of electronic device. The mobile device 102 can be implemented with various components, such as a processor system and memory, as well as any number and combination of different components as further described with reference to the example device shown in FIG. 9.

In implementations, the mobile device 102 includes a camera device 104, or multiple camera devices. For example, the mobile device 102 may be a dual-camera or multi-camera device, and include a front-facing camera and at least one rear-facing camera. Generally, the front-facing camera (e.g., the camera device 104) includes a camera lens 106 that is integrated in or around a display screen 108 of the device, and the front-facing camera faces the user of the device as he or she holds the device in a position to view the display screen. The camera device 104 also has a camera imager 110 that receives light directed through the camera lens, which is then captured as image content 112 (e.g., digital image content, digital photos). Users commonly use the front-facing camera to take pictures or videos (e.g., digital images) of themselves, such as self-portrait digital images often referred to as “selfies.” Generally, the image content 112 may include depictions of one or more objects, to include an image or video of the user of the device and/or objects viewable within the field-of-view of the camera device. Similarly, a rear-facing camera (e.g., also an example of the camera device 104) includes a camera lens that is integrated in the back cover or housing of the device, and faces away from a user of the device toward the surrounding environment.

In this example system 100, the camera device 104 includes the camera imager 110, which has a noncircular aperture 114, such as a slit aperture or a rectangular aperture, or generally, any type of asymmetrical aperture that is shaped as something other than a conventional circular aperture. Given the limited adjustment flexibility of a fixed focal length camera in the compact form factor of the mobile device 102, the camera imager 110 captures the image content 112 (e.g., a digital photo) at the particular depth of field 116 of the camera, which can result in distortions in the image content that are very characteristic. Notably, the image content 112 that is captured by the camera imager 110 has an identifiable characteristic 118 resulting from the noncircular aperture 114 of the camera imager, and this identifiable characteristic 118 can be utilized as a basis to sharpen a distorted portion of the image content.

The camera device 104 (or the mobile device 102 that implements the camera device) includes various functionality that enables the camera device to implement techniques of adaptive depth of field for a noncircular aperture, as described herein. In this example system 100, the camera device 104 includes a content manager 120 that represents functionality (e.g., logic, software, and/or hardware) enabling the camera device 104 to adaptively adjust the perceived depth of field 116 to sharpen at least a portion of the image content 112 based on the identifiable characteristic 118 resulting from the noncircular aperture 114 of the camera imager. The content manager 120 can be implemented as computer instructions stored on computer-readable storage media and can be executed by a processor system of the camera device 104 and/or of the mobile device 102. Alternatively or in addition, the content manager 120 can be implemented at least partially in hardware of a device.

In one or more implementations, the content manager 120 may include independent processing, memory, and/or logic components functioning as a computing and/or electronic device integrated with the camera device 104 and/or with the mobile device 102. Alternatively or in addition, the content manager 120 can be implemented in software, in hardware, or as a combination of software and hardware components. In this example, the content manager 120 is implemented as a software application or module, such as executable software instructions (e.g., computer-executable instructions) that are executable with a processor system of the camera device 104 and/or the mobile device 102 to implement the techniques and features described herein.

As a software application or module, the content manager 120 can be stored on computer-readable storage memory (e.g., memory of a device), or in any other suitable memory device or electronic data storage implemented with the module. Alternatively or in addition, the content manager 120 may be implemented in firmware and/or at least partially in computer hardware. For example, at least part of the content manager 120 may be executable by a computer processor, and/or at least part of the content manager may be implemented in logic circuitry. As a device application implemented by the camera device 104 and/or the mobile device 102, the content manager 120 may have an associated application user interface that is generated and displayable for user interaction and viewing. Generally, an application user interface, or any other type of video, image, graphic, and the like is digital image content that is displayable on the display screen 108 of the mobile device 102.

In aspects of the described techniques, the content manager 120 is implemented to adaptively adjust the perceived depth of field 116 to sharpen at least a portion of the image content 112 based on the identifiable characteristic 118 resulting from the noncircular aperture 114 of the camera imager 110. In an implementation, the content manager 120 adaptively adjusts the perceived depth of field 116 by increasing the perceived depth of field to compensate for the identifiable characteristic 118 in the image content 112 resulting from the noncircular aperture 114. In at least some image content, the identifiable characteristic 118 resulting from the noncircular aperture 114 of the camera imager 110 is a distortion of at least a portion of the image content (e.g., the portion of the image content is out of focus). Accordingly, the content manager 120 can increase the perceived depth of field 116 to compensate for the distortion in the image content.

In another implementation, the content manager 120 can utilize optical properties 122 of the camera lens 106 of the camera device 104 used to capture the image content 112. The depth of field issues can also be addressed using the optical properties 122 of the specific camera lens 106 being used in the device, and inverting the effects that the camera optics have on the perceived depth of field. More specifically, a large set of optical point spread functions (PSFs) can be calculated for the camera device 104, and used to degrade a set of reference images. In one or more implementations, these reference and degraded images can then be used by a machine learning model 126 to estimate the inverse of these PSF functions. The resulting model can then be used on-device (e.g., on the camera device 104 and/or on the mobile device 102) to selectively (by virtue of the ML model) invert the perceived depth of field artifacts produced by the camera imager.

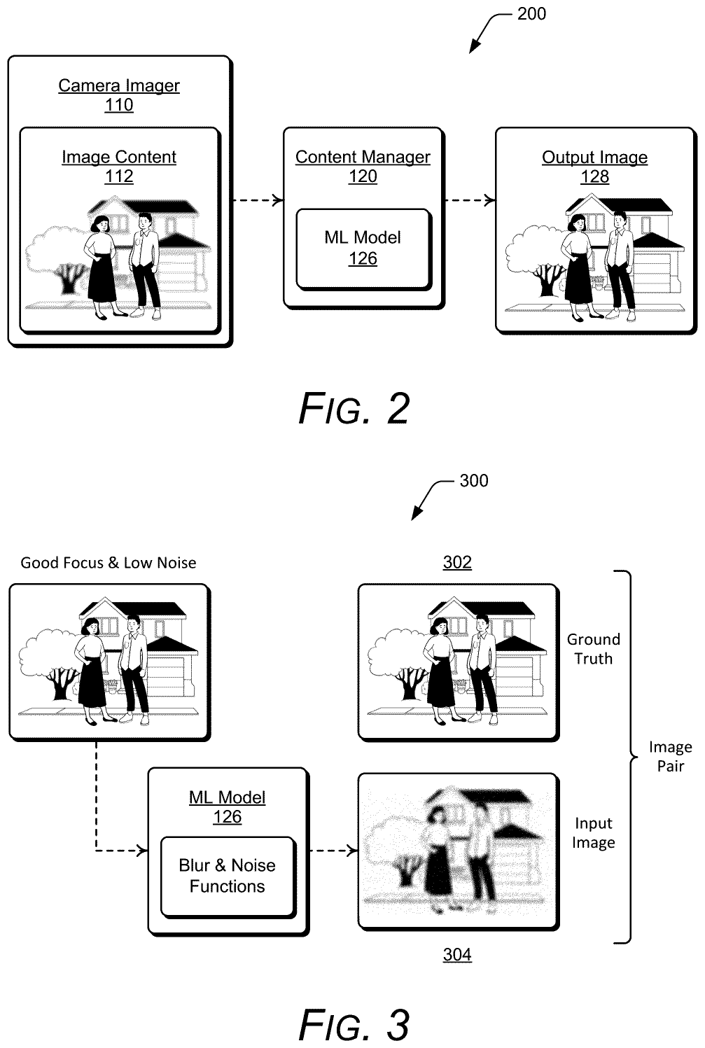

In one or more implementations, the content manager 120 includes, or is implemented as, the machine learning model 126 (e.g., an AI model) that corrects a blur and/or reduces noise of the distorted portion of the image content 112. Notably, when an image is enhanced, denoising is inherently a part of the enhancing the image. FIG. 2 illustrates an example 200 of the machine learning model 126 (of the content manager 120) processing image content 112 with a blurry region to generate a sharpened output image 128. In aspects of the described techniques, the machine learning model 126 is trained to learn an inverse image of the image content 112, such as trained with the one or more training images 124 converted to have characteristics of images captured with a mobile phone camera. In implementations, the machine learning model 126 is trained with one or more training images 124 that have sharp foreground content and blurry background content, and a sharpened output image 128 of the content manager is then sharpened image content.

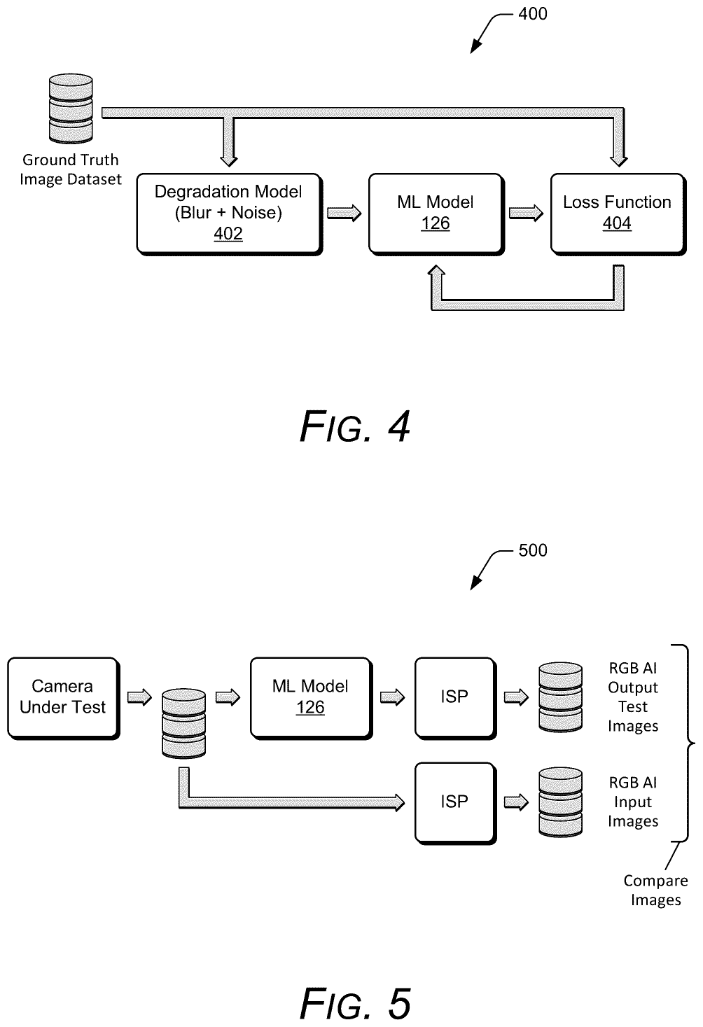

FIG. 3 illustrates an example 300 of a degradation model usable to generate a training image pair. A first image 302 of the training image pair has high resolution, low noise, and a large depth of field (e.g., a ground truth image), and has very sharp content throughout. In implementations, the ground truth image is the desired image, which should be in good-focus everywhere (based on depth of field) and should have a large signal to noise ratio (SNR). For SNR, a camera with large pixel size will collect more light which improves the SNR, and images are captured at the lowest camera ISO speed (e.g., ISO 100). At a low ISO speed (gain), more light needs to be collected for a good exposure which improves the SNR. Additionally, to make sure the image is sharp at all distances, the aperture is “stopped down” (e.g., to a large f-number), which reduces focal aberrations (blur) in the lens and results in an image with a large depth of field. Further, all objects in the image are at a similar distance which helps reduce focal aberrations.

In the example 300, a second image 304 of the training image pair is generated by blurring and adding noise to the first image (e.g., representative of a captured input image). The machine learning model 126 is trained to deblur and denoise the second image, inverted back to the ground truth first image. Further, a lens transfer function utilized for training may be used to develop a blur function based on the optical properties 122 of the camera lens 106. In implementations, multiple blur functions are developed for the multiple different focal distances and positions. Additionally, adding noise to the image is based on the conventional physics of light in an environment in which an input image is captured. One of difficulties in sharpening a blurred image is the presence of noise. The ground truth images are captured such that they have very little noise (big pixels & low ISO speed). Accordingly, the noise can then be added to the ground truth images to simulate practical images. The noise is due to the random way that photons of light hit the camera lens, and this randomness follows the Poisson distribution, which is better known as “Shot Noise” and for a Poisson distribution, the standard deviation (the noise) is equal to the square root of the signal. Therefore, the SNR is equal to the square root of the signal.

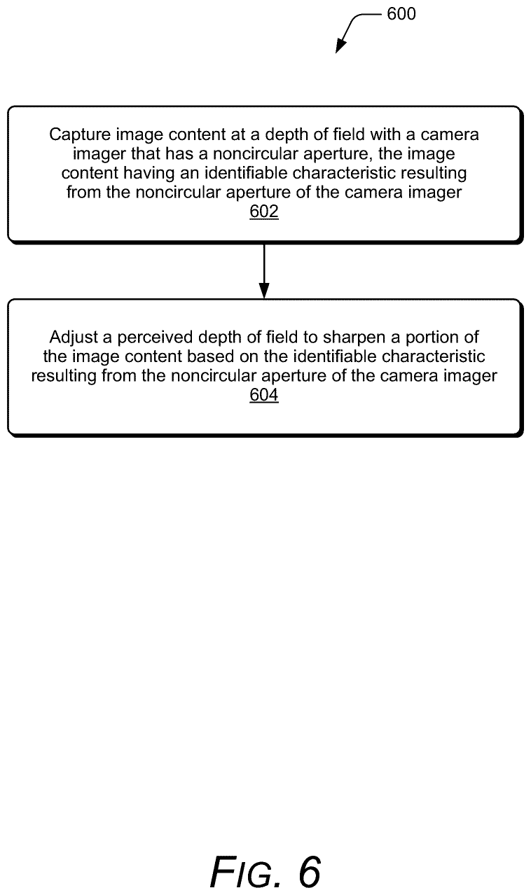

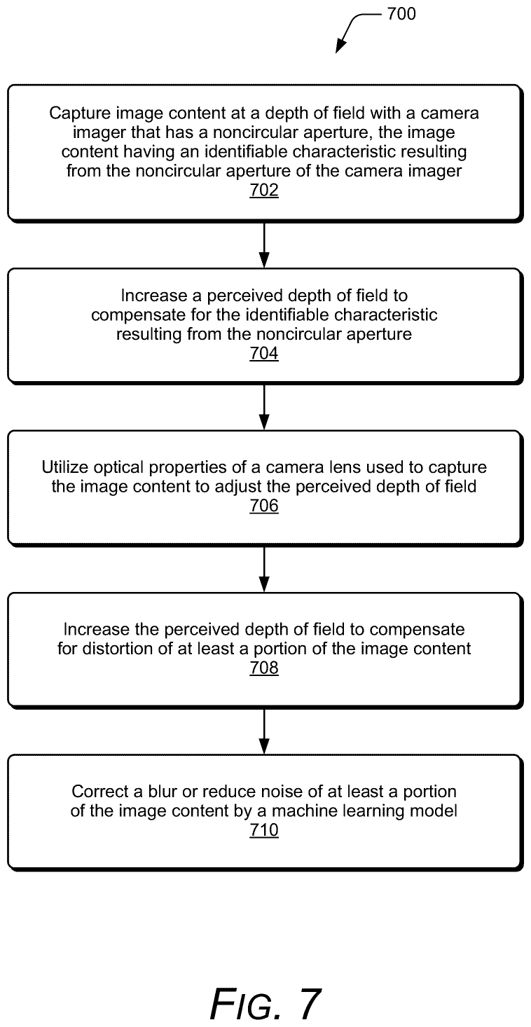

Further, as noted above, the one or more training images 124 can be converted to a format that makes it look as if the one or more training images 124 were captured specifically from a mobile phone, such as for application in this example system 100. FIG. 4 further illustrates an example 400 of training the machine learning model 126 (e.g., an AI model) to learn the inverse of a degradation model 402 based at least in part on a loss function 404. FIG. 5 further illustrates an example 500 of processing test images through the trained machine learning model 126.

In further aspects of the described techniques to adaptively adjust the perceived depth of field, the content manager 120 is implemented to segregate the image content 112 of a captured image into region slices, separately process each region slice to compensate for the identifiable characteristic 118 resulting from the noncircular aperture 114, and stitch compensated region slices back together to generate the sharpened output image 128 of the image content. This utilizes less processing and memory resources on the device, particularly by the machine learning model 126 when sharpening a captured input image. In other aspects, and as illustrated in the example system 100, the machine learning model 126 is implemented in the image processing pipeline as close to the camera imager 110 as allowable by the system configuration so that the machine learning model is processing the initial data of the captured image content 112 before all of the other conventional image processing 130 that may otherwise distort or alter the captured image content.

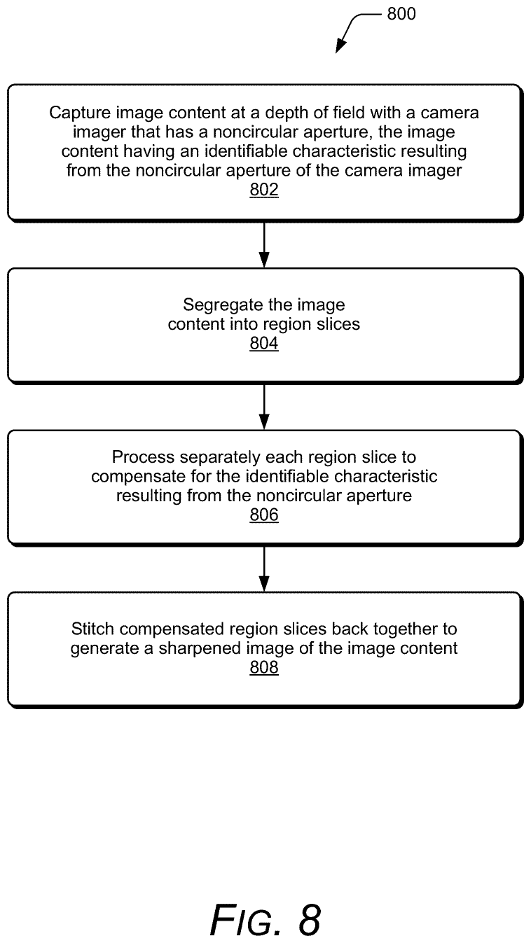

Example methods 600, 700, and 800 are described with reference to respective FIGS. 6, 7, and 8 in accordance with one or more implementations of adaptive depth of field for a noncircular aperture, as described herein. Generally, any services, components, modules, managers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 for adaptive depth of field for a noncircular aperture. The order in which the method is described is not intended to be construed as a limitation, and any number or combination of the described method operations can be performed in any order to perform a method, or an alternate method.

At 602, image content is captured at a depth of field with a camera imager that has a noncircular aperture, the image content having an identifiable characteristic resulting from the noncircular aperture of the camera imager. For example, the camera imager 110 has the noncircular aperture 114, such as a slit aperture, a rectangular aperture, or an aperture that is shaped as something other than a conventional circular aperture. The camera imager 110 captures the image content 112 at a particular depth of field 116, and the image content has an identifiable characteristic 118 resulting from the noncircular aperture of the camera imager.

At 604, a perceived depth of field is adjusted to sharpen a portion of the image content based on the identifiable characteristic resulting from the noncircular aperture of the camera imager. For example, the content manager 120 adaptively adjust the perceived depth of field 116 to sharpen at least a portion of the image content 112 based on the identifiable characteristic 118 resulting from the noncircular aperture 114 of the camera imager. In implementations, the content manager 120 adaptively adjusts the perceived depth of field 116 by increasing the perceived depth of field to compensate for the identifiable characteristic 118 in the image content 112 resulting from the noncircular aperture 114. In at least some image content, the identifiable characteristic 118 resulting from the noncircular aperture 114 of the camera imager 110 is a distortion of at least a portion of the image content (e.g., the portion of the image content is out of focus). Accordingly, the content manager 120 increases the perceived depth of field 116 to compensate for the distortion in the image content. In another implementation, the content manager 120 utilizes optical properties 122 of the camera lens 106 of the camera device 104 used to capture the image content 112.

FIG. 7 illustrates example method(s) 700 for adaptive depth of field for a noncircular aperture. The order in which the method is described is not intended to be construed as a limitation, and any number or combination of the described method operations can be performed in any order to perform a method, or an alternate method.

At 702, image content is captured at a depth of field with a camera imager that has a noncircular aperture, the image content having an identifiable characteristic resulting from the noncircular aperture of the camera imager. For example, the camera imager 110 has the noncircular aperture 114, such as a slit aperture, a rectangular aperture, or an aperture that is shaped as something other than a conventional circular aperture. The camera imager 110 captures the image content 112 at a particular depth of field 116, and the image content has an identifiable characteristic 118 resulting from the noncircular aperture of the camera imager.

At 704, a perceived depth of field is increased to compensate for the identifiable characteristic resulting from the noncircular aperture. For example, the content manager 120 adaptively adjusts the perceived depth of field 116 to sharpen a portion of the image content by increasing the perceived depth of field to compensate for the identifiable characteristic 118 in the image content 112 resulting from the noncircular aperture 114.

At 706, optical properties of a camera lens used to capture the image content are utilized to adjust the perceived depth of field. For example, the content manager 120 adaptively adjusts the perceived depth of field 116 utilizing optical properties 122 of the camera lens 106 of the camera device 104 used to capture the image content 112.

At 708, the perceived depth of field is increased to compensate for distortion of at least a portion of the image content. In at least some image content, the identifiable characteristic 118 resulting from the noncircular aperture 114 of the camera imager 110 is a distortion of at least a portion of the image content (e.g., the portion of the image content is out of focus). Accordingly, the content manager 120 increases the perceived depth of field 116 to compensate for the distortion in the image content.

At 710, a blur is corrected or noise reduced of at least a portion of the image content by a machine learning model. For example, the content manager 120 includes, or is implemented as, the machine learning model 126 (e.g., an AI model) that corrects a blur and/or reduces noise of the distorted portion of the image content 112.

FIG. 8 illustrates example method(s) 800 for adaptive depth of field for a noncircular aperture. The order in which the method is described is not intended to be construed as a limitation, and any number or combination of the described method operations can be performed in any order to perform a method, or an alternate method.

At 802, image content is captured at a depth of field with a camera imager that has a noncircular aperture, the image content having an identifiable characteristic resulting from the noncircular aperture of the camera imager. For example, the camera imager 110 has the noncircular aperture 114, such as a slit aperture, a rectangular aperture, or an aperture that is shaped as something other than a conventional circular aperture. The camera imager 110 captures the image content 112 at a particular depth of field 116, and the image content has an identifiable characteristic 118 resulting from the noncircular aperture of the camera imager.

At 804, the image content is segregated into region slices. For example, the content manager 120 segregates the image content 112 of a captured image into region slices. At 806, each region slice is processed separately to compensate for the identifiable characteristic resulting from the noncircular aperture. For example, the content manager 120 separately processes each region slice to compensate for the identifiable characteristic 118 resulting from the noncircular aperture 114. At 808, compensated region slices are stitched back together to generate a sharpened image of the image content. For example, the content manager 120 stitches compensated region slices back together to generate the sharpened output image 128 of the image content.

FIG. 9 illustrates various components of an example device 900, which can implement aspects of the techniques and features for adaptive depth of field for a noncircular aperture, as described herein. The example device 900 can be implemented as any of the devices described with reference to the previous FIGS. 1-8, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or camera device 104 described with reference to FIGS. 1-8 may be implemented as the example device 900.

The example device 900 can include various, different communication devices 902 that enable wired and/or wireless communication of device data 904 with other devices. The device data 904 can include any of the various devices data and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The I/O interfaces 906 can be used to couple the device to any type of components, peripherals, and/or accessory devices, such as a computer input device that may be integrated with the example device 900. The I/O interfaces 906 may also include data input ports via which any type of data, information, media content, communications, messages, and/or inputs can be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 can be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes a content manager 918 that implements various aspects of the described features and techniques described herein. The content manager 918 can be implemented with hardware components and/or in software as one of the device applications 914, such as when the example device 900 is implemented as the mobile device 102 and/or as the camera device 104 described with reference to FIGS. 1-8. An example of the content manager 918 is the content manager 120 implemented with the machine learning model 126 by the camera device 104, such as a software application and/or as hardware components in the device. In one or more implementations, the content manager 918 may also implement the degradation model 402. In implementations, the content manager 918 may include independent processing, memory, and logic components as a computing and/or electronic device integrated with the example device 900.

The example device 900 can also include a microphone 920 and/or camera devices 922, as well as motion sensors 924, such as may be implemented as components of an inertial measurement unit (IMU). The motion sensors 924 can be implemented with various sensors, such as a gyroscope, an accelerometer, and/or other types of motion sensors to sense motion of the device. The motion sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations of adaptive depth of field for a noncircular aperture have been described in language specific to features and/or methods, the appended claims are not necessarily limited to the specific features or methods described. Rather, the specific features and methods are disclosed as example implementations of adaptive depth of field for a noncircular aperture, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A camera device, comprising: a camera imager with a noncircular aperture, the camera imager configured to capture image content at a depth of field, the image content having an identifiable characteristic resulting from the noncircular aperture of the camera imager; and a content manager implemented at least partially in computer hardware and configured to adaptively adjust a perceived depth of field to sharpen at least a portion of the image content based at least in part on the identifiable characteristic resulting from the noncircular aperture of the camera imager.

Alternatively or in addition to the above described camera device, any one or combination of: to adaptively adjust the perceived depth of field, the content manager is configured to increase the perceived depth of field to compensate for the identifiable characteristic resulting from the noncircular aperture. To adaptively adjust the perceived depth of field, the content manager is configured to utilize optical properties of at least a camera lens of the camera device used to capture the image content. The identifiable characteristic resulting from the noncircular aperture of the camera imager is a distortion of at least the portion of the image content. To adaptively adjust the perceived depth of field, the content manager is configured to increase the perceived depth of field to compensate for the distortion of at least the portion of the image content. The content manager is a machine learning model configured to at least one of correct a blur or reduce noise of at least the portion of the image content. The machine learning model is trained to learn an inverse image of the image content. The machine learning model is trained with one or more training images converted to have characteristics of images captured with a mobile phone camera having an asymmetric aperture. The machine learning model is trained with one or more training images that have sharp foreground content and blurry background content, and an output of the content manager is sharpened image content. The machine learning model is trained with a training image pair, a first image of the training image pair having high resolution, low noise, and a large depth of field, and a second image of the training image pair is generated by blurring and adding noise to the first image. To adaptively adjust the perceived depth of field, the content manager is configured to segregate the image content into region slices, separately process each region slice to compensate for the identifiable characteristic resulting from the noncircular aperture, and stitch compensated region slices back together to generate a sharpened image of the image content.

A method, comprising: capturing image content at a depth of field with a camera imager that has a noncircular aperture, the image content having an identifiable characteristic resulting from the noncircular aperture of the camera imager; and adjusting the perceived depth of field to sharpen at least a portion of the image content based at least in part on the identifiable characteristic resulting from the noncircular aperture of the camera imager.

Alternatively or in addition to the above described method, any one or combination of: increasing the perceived depth of field to compensate for the identifiable characteristic resulting from the noncircular aperture. The method further comprising utilizing optical properties of at least a camera lens used to capture the image content to adjust the perceived depth of field. The method further comprising: increasing the perceived depth of field to compensate for distortion of at least the portion of the image content, wherein the identifiable characteristic resulting from the noncircular aperture of the camera imager is the distortion of at least the portion of the image content. The method further comprising at least one of correcting a blur or reducing noise of at least the portion of the image content by a machine learning model. The method further comprising segregating the image content into region slices; processing separately each region slice to compensate for the identifiable characteristic resulting from the noncircular aperture; and stitching compensated region slices back together to generate a sharpened image of the image content.

A system, comprising: a camera imager with a noncircular aperture, the camera imager configured to capture image content at a depth of field, the image content having an identifiable characteristic resulting from the noncircular aperture of the camera imager; and a machine learning model configured to compensate for distortion in the image content attributable to the identifiable characteristic resulting from the noncircular aperture of the camera imager.

Alternatively or in addition to the above described system, any one or combination of: the machine learning model is configured to at least one of correct a blur or reduce noise of at least a portion of the image content. The machine learning model is configured to adaptively adjust a perceived depth of field to compensate for the distortion in the image content that is attributable to the identifiable characteristic resulting from the noncircular aperture of the camera imager.

1. A camera device, comprising:
a camera imager with a noncircular aperture, the camera imager configured to capture image content at a depth of field, the image content having an identifiable characteristic resulting from the noncircular aperture of the camera imager; and
a content manager implemented at least partially in computer hardware and configured to adaptively adjust a perceived depth of field to sharpen at least a portion of the image content based at least in part on the identifiable characteristic resulting from the noncircular aperture of the camera imager.

2. The camera device of claim 1, wherein, to adaptively adjust the perceived depth of field, the content manager is configured to increase the perceived depth of field to compensate for the identifiable characteristic resulting from the noncircular aperture.

3. The camera device of claim 1, wherein, to adaptively adjust the perceived depth of field, the content manager is configured to utilize optical properties of at least a camera lens of the camera device used to capture the image content.

4. The camera device of claim 1, wherein the identifiable characteristic resulting from the noncircular aperture of the camera imager is a distortion of at least the portion of the image content.

5. The camera device of claim 4, wherein, to adaptively adjust the perceived depth of field, the content manager is configured to increase the perceived depth of field to compensate for the distortion of at least the portion of the image content.

6. The camera device of claim 1, wherein the content manager is a machine learning model configured to at least one of correct a blur or reduce noise of at least the portion of the image content.

7. The camera device of claim 6, wherein the machine learning model is trained to learn an inverse image of the image content.

8. The camera device of claim 6, wherein the machine learning model is trained with one or more training images converted to have characteristics of images captured with a mobile phone camera having an asymmetric aperture.

9. The camera device of claim 6, wherein the machine learning model is trained with one or more training images that have sharp foreground content and blurry background content, and an output of the content manager is sharpened image content.

10. The camera device of claim 6, wherein the machine learning model is trained with a training image pair, a first image of the training image pair having high resolution, low noise, and a large depth of field, and a second image of the training image pair is generated by blurring and adding noise to the first image.

11. The camera device of claim 1, wherein, to adaptively adjust the perceived depth of field, the content manager is configured to segregate the image content into region slices, separately process each region slice to compensate for the identifiable characteristic resulting from the noncircular aperture, and stitch compensated region slices back together to generate a sharpened image of the image content.

12. A method, comprising:
capturing image content at a depth of field with a camera imager that has a noncircular aperture, the image content having an identifiable characteristic resulting from the noncircular aperture of the camera imager; and
adjusting a perceived depth of field to sharpen at least a portion of the image content based at least in part on the identifiable characteristic resulting from the noncircular aperture of the camera imager.

13. The method of claim 12, further comprising:
increasing the perceived depth of field to compensate for the identifiable characteristic resulting from the noncircular aperture.

14. The method of claim 12, further comprising:
utilizing optical properties of at least a camera lens used to capture the image content to adjust the perceived depth of field.

15. The method of claim 12, further comprising:
increasing the perceived depth of field to compensate for distortion of at least the portion of the image content, wherein the identifiable characteristic resulting from the noncircular aperture of the camera imager is the distortion of at least the portion of the image content.

16. The method of claim 12, further comprising at least one of:
correcting a blur or reducing noise of at least the portion of the image content by a machine learning model.

17. The method of claim 12, further comprising:
segregating the image content into region slices;
processing separately each region slice to compensate for the identifiable characteristic resulting from the noncircular aperture; and
stitching compensated region slices back together to generate a sharpened image of the image content.

18. A system, comprising:
a camera imager with a noncircular aperture, the camera imager configured to capture image content at a depth of field, the image content having an identifiable characteristic resulting from the noncircular aperture of the camera imager; and
a machine learning model configured to compensate for distortion in the image content attributable to the identifiable characteristic resulting from the noncircular aperture of the camera imager.

19. The system of claim 18, wherein the machine learning model is configured to at least one of correct a blur or reduce noise of at least a portion of the image content.

20. The system of claim 18, wherein the machine learning model is configured to adaptively adjust a perceived depth of field to compensate for the distortion in the image content that is attributable to the identifiable characteristic resulting from the noncircular aperture of the camera imager.
